(19) United States
(12) Patent Application Publication
(10) Pub. No.: US 2021/0043334 A1
(43) Pub. Date: Feb. 11, 2021

(54) Argon Fluoride Laser-Driven Inertial Fusion Energy System

(71) Applicant: The Government of the United States of America, as represented by the Secretary of the Navy, Arlington, VA (US)

(72) Inventors: Stephen P. Obenschain, Springfield, VA (US); Malcolm W. McGeoch, Little Compton, RI (US); Matthew Wolford, Washington, DC (US); Andrew Schmitt, Arlington, VA (US); Matthew Myers, Beltsville, MD (US); Max Karasik, Washington, DC (US); James Weaver, Silver Spring, MD (US); Jason Bates, Washington, DC (US)

(73) Assignee: The Government of the United States of America, as represented by the Secretary of the Navy, Arlington, VA (US)

(21) Appl. No.: 16/987,485

(22) Filed: Aug. 7, 2020

Related U.S. Application Data
(60) Provisional application No. 62/884,686, filed on Aug. 9, 2019.

(51) Int. Cl. G21B 1/23; G21B 1/05; H01S 3/225

(52) U.S. Cl. CPC G21B 1/23; H01S 3/0071; H01S 3/2251; G21B 1/05

(57) ABSTRACT

An argon fluoride (ArF) laser system for inertial nuclear fusion energy production with lower required laser energy than other laser drivers. An Argon fluoride laser system uniformly illuminates a spherical capsule comprising an outer ablator wall surrounding an inner shell comprising the fusion fuel. The laser beams are adjusted spectrally to achieve a bandwidth of up to 12 THz and a coherence time as low as 80 femtoseconds that in combination with the short wavelength (193 nm) suppress laser plasma instabilities. Uniform spherical acceleration causes the inner shell of the target capsule to form a spherical assembly of compressed fuel surrounding a “hot spot” that has sufficient temperature, density and size to ignite and initiate a thermonuclear burn.

### CROSS-REFERENCE

This application is a Nonprovisional of and claims the benefit of priority under 35 U.S.C. § 119 based on U.S. Provisional Patent Application No. 62/884,686 filed Aug. 9, 2019. The Provisional Application and all references cited herein are hereby incorporated by reference into the present disclosure in their entirety.

### FEDERALLY-SPONSORED RESEARCH AND DEVELOPMENT

The United States Government has ownership rights in this invention. Licensing inquiries may be directed to Office of Technology Transfer, U.S. Naval Research Laboratory, Code 1004, Washington, D.C. 20375, USA; +1.202.767.7230; techtran@nrl.navy.mil, referencing Navy Case #111474.

### TECHNICAL FIELD

The present disclosure relates to inertial confinement fusion, in particular to a method for generating energy via inertial confinement fusion by illuminating a spherical target containing deuterium-tritium fuel with a high-energy laser beams to effect a high velocity (100's of km/sec) implosion.

### BACKGROUND

The power source for the sun and stars was a mystery for many years prior to the discovery of nuclear energy. The power provided by the sun was much too high to be sustained for many millions of years by any known chemical reaction or even by gravitational collapse of its huge mass.

In the 1930's it was postulated that nuclear fusion, where two light nuclei combine to form a new nucleus with the release of large amounts of energy, is the power source for the sun.

That postulate is now accepted, although details of the reactions occurring in the sun are not totally resolved. The high pressures and temperatures within the sun allow the slow thermonuclear burn of hydrogen (single proton isotope). This is not a practical reaction for experiments on Earth.

There are, however, other fusion reactions that are easier to achieve. Deuterium (one proton and one neutron) and tritium (one proton and two neutrons) have much higher thermonuclear reactions rates at a given temperature than two hydrogen nuclei. Deuterium is plentiful in seawater, with enough available to provide sufficient fusion fuel for all power needs on Earth for billions of years. Although tritium is not a naturally occurring element and must be manufactured by nuclear transformation of lithium, there is enough lithium readily available to accommodate the power needs of the world for thousands of years.

The DT reaction is the principal fuel for all mainline approaches to fusion on Earth. However, the DT reaction requires that the DT fuel be heated to high temperature (greater than 100,000,000 degrees Celsius) and confined for long enough time for a high percentage of the fuel toundergo fusion. But no material can withstand the high temperature required for the fusion reactions.

Two approaches are available to solve that. At such high temperatures the DT fuel is ionized and forms a plasma. This plasma in principle can be confined by magnetic fields, and this is the main effort worldwide to achieve practical fusion energy. However, there are instabilities that make this approach challenging, and the largest experiment, called ITER, is very expensive and may not lead to practical power source for electricity production.

Another approach is so-called inertial confinement fusion where one compresses and heats the DT fuel to such a high density that a large fraction of it undergoes thermonuclear reactions before expanding. This was first achieved in thermonuclear weapons where a nuclear fission device provided the drive energy to heat and compress the fusion fuel. At that time there was no driver available to scale down inertial confinement fusion to a practical size for laboratory experiments and practical applications.

The invention of the laser provided a potential driver for inertial confinement fusion. It has been the most investigated approach to laboratory-scale inertial fusion for over 50 years. See J. Nuckolls et al, “Laser Compression of Matter to Super-High Densities: Thermonuclear (CTR) Applications,” Nature 239, 139-142 (1972). Other drivers such as pulsed ion beams have been considered, but are not nearly as well developed and their prospects are unknown. Laser drivers that have been seriously considered in the past include diode pumped solid-state lasers and the krypton fluoride (KrF) excimer laser. See I. N. Sviatoslaysky et al., “KrF laser driven inertial fusion reactor ‘SOMBRERO’,” Fusion Technology Volume 21, Issue 3 pt 2A, May 1992, Pages 1470-1474; W. R. Meier, “Osirus and SOMBRERO inertial fusion power plant designs—summary, conclusions and recommendations,” Fusion Engineering and Design, vol. 25, pp. 145-157, 1994; J. D. Sethian et al., “Electron Beam Pumped Krypton Fluoride Lasers for Fusion Energy,” Proceedings of the IEEE, vol. 92, no. 7, pp. 1043-1056, 2004; and C. D. Orth et al., “A diode pumped solid state laser driver for inertial fusion energy,” Nuclear Fusion Volume 36, Issue 1, January 1996, pp. 75-116.

The development of internal confinement fusion (ICF) as an energy source has stalled to a large degree because of the limits of the laser technology employed for ICF research and the eventual inertial fusion energy application.

The physics of laser fusion is being investigated by a large research programs in the United States and elsewhere. The largest facilities in the United States are the National Ignition facility (NIF) located at Lawrence Livermore National Laboratory and the OMEGA facility located at the University of Rochester.

Both facilities utilize frequency-tripled Nd:glass lasers (351 nm wavelength). The OMEGA facility concentrates on the direct drive approach where the laser beams directly illuminate a spherical target at high intensity and the resulting high pressure drives an implosion. The NIF has concentrated on the indirect drive approach where the laser light illuminates the wall of a gold cylinder (called a hohlraum) and the resulting x-rays drive the implosion contained in the center of the cylinder.

The NIF so far after a ten-year effort has not achieved the goal of ignition in which the fusion energy output equals the laser energy entering the hohlraum. There are numerous issues that have prevented ignition including the fact that indirect drive is inefficient and the NIF has marginal energy to achieve ignition with that approach. The most fundamental reason for failure of the NIF to reach ignition is the occurrence of laser-plasma instabilities (LPIs), which can spoil the symmetry of indirect drive implosions and cause significant backscatter of laser light out of the hohlraum. See D. S. Montgomery, “Two decades of progress in understanding and control of laser-plasma instabilities in indirect drive inertial fusion,” Phys. Plasmas, vol. 23, pp. 055601-1-055601-15, 2016.

The OMEGA facility is too small to effect ignition, so it is utilized to test the fundamental physics of direct drive implosions. Direct drive has the potential to be much more efficient than indirect drive ICF and to achieve the high energy gains needed for inertial fusion energy (IFE) applications. See U.S. Pat. No. 4,608,222 to Bruekner. However, LPI has also limited the performance of the OMEGA facility. A form of LPI called cross beam energy transfer (CBET) redirects the incoming laser beams and cause a 30% effect loss in the laser energy. See R. Craxton, et al., “Direct-drive inertial confinement fusion: A review,” Physics of Plasmas, vol. 22, pp. 110501-1-110501-153, 2015.

For both NIF and OMEGA, LPI limits the maximum laser intensity that can be utilized and that limits the pressure that can be applied to drive an implosion. For both facilities the limited pressure that can be applied requires use of targets that have thinner shells and larger radii than would be needed at higher pressures. These high aspect ratio targets (outer radius/shell thickness) are more susceptible to hydrodynamic instabilities during the implosion.

Given the limitations of the frequency tripled Nd:glass light utilized by current laser facilities it is very unlikely that they can enable high performance fusion implosions, and new laser technologies are needed. There are two complementary avenues to improve the laser target coupling efficiency for fusion implosions: (1) utilize shorter wavelength laser light, which suppresses LPI and improves the hydro-efficiency of direct drive implosions and (2) utilize multi-THz laser bandwidth to suppress both LPI and laser imprint. The technology to go to shorter than 351 nm wavelength with Nd:glass or other similar solid-state lasers does not exist. In addition, the bandwidth of current frequency tripled lasers is limited to about 0.5 THz before the conversion efficiency suffers. The krypton fluoride (KrF) laser is an alternative laser technology for ICF that can provide shorter wavelength and can provide higher bandwidth light on target. The present world leader in high-energy KrF lasers for both the ICF and IFE applications is the laser fusion program at the U.S. Naval Research Laboratory (NRL). The KrF work at NRL is briefly described below.

NRL has operated the Nike krypton fluoride (KrF) laser for 24 years with a small crew and no high-cost maintenance issues. See S. Obenschain et al., “High-energy krypton fluoride lasers for inertial fusion,” Applied Optics, vol. 54, no. 31, pp. F103-F122, 2015. KrF has shorter wavelength (248 nm vs 351 nm), and broader demonstrated bandwidth (3×) than that employed on NIF and OMEGA. In addition, the induced spatial incoherence (ISI) beam smoothing provides superior illumination uniformity. See U.S. Pat. No. 4,790,627 to Lehmberg; see also U.S. Pat. No. 4,521,075 to Obenschain and Lehmberg. In addition the focal diameter can easily be zoomed down to better match the shrinking radius of imploding target. Zooming thereby increases the coupling efficiency to a direct drive target and mitigates CBET; however, while zooming has been demonstrated on the Nike facility, it cannot be implemented on current Nd:glass ICF laser facilities.

The advantage of ArF and KrF excimer lasers for the target physics of inertial fusion has been discussed in the literature since the late 1970's because of their short laser wavelength. However, prior to the recent work at NRL, there had been no simulations to our knowledge of the advantages of ArF's short wavelength (193 nm) light, so there was no means to quantify its advantages for obtaining the target performance required for inertial fusion energy.

A brief discussion of previous work on high energy ArF lasers is provided below. The work was done in the late 1970's and 1980's. By the end of the 1980's work on high-energy ArF was abandoned in favor of developing KrF. This was most likely because the optics required for KrF's longer wavelength were perceived to be easier to fabricate than those needed for ArF. That concern has been ameliorated by development of durable ArF optics for lithography.

High energy ArF lasers have been dismissed in the past as too difficult to develop and build. So far, the NRL effort indicates that high energy ArF lasers can be built, and that the payoff for laser ICF could be “game changing.” The first explicit experimental exploration of ArF (wavelength 193 nm) for this purpose was by Alex Mandl, published in 1986. See A. Mandl, “ArF short-pulse extraction studies,” J. Appl. Phys. 59, 1435-1445 (1986). His conclusion, based upon the measurements he reported, was that both the ArF* and KrF* laser systems (where the asterisk indicates that the ArF and KrF molecules are in their excited states) offer exciting potential as inertial confinement fusion drivers, with ArF* offering the real possibility of a very intense, high joule per liter, efficient source and the 193 nm wavelength offering some gain in the target-compression physics. Mandl noted, however, that a key outstanding issue at the time was the performance of optics at ArF very short wavelength.

Shortly after Mandl, Suda et al. proved experimentally that neon-free ArF laser mixtures could be more efficient than KrF. See A. Suda et al., “Performance characteristics of the ArF excimer laser using a low-pressure argon-rich mixture,” J. Appl. Phys. 60, 3791-3793 (1986). Suda concluded that as a result, the ArF laser in such an operational regime was found to be a better candidate than the KrF laser for an ICF driver, although the quality of optics at 193 nm could still be improved.

Prior to Mandl and Suda, there been other discussions of ArF and KrF as candidates for an ICF driver, see, e.g., C. B. Edwards et al., “60-ns E-beam excitation of rare-gas halide lasers,” Applied Physics Letters Volume 36, Issue 8, 1980, Pages 617-620, but there had not been prior experimental results that showed the superiority of ArF as a laser in terms of efficiency and suitability for high-energy pulse generation for ICF.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

The present invention provides a laser-driven inertial fusion energy system and method for generating power using laser-driven inertial fusion.

A laser-driven inertial energy fusion system in accordance with the present invention can include multiple ArF laser beams produced by multiple ArF beamlines, where the ArF laser beams can be used to directly illuminate a spherical target comprising an outer ablator wall surrounding an inner shell comprising the fusion fuel.

In some embodiments, the beams are configured to have the same pulse shape, and the lasers are fired according to a predetermined sequence such that the beams arrive simultaneously (to within about 0.01 ns) at the capsule to form an ArF laser drive that implodes the capsule. In other embodiments, some of the beams are configured to have a different pulse shape and are delayed by a predetermined time with respect to the other laser beams to provide the required drive on target. For example, shock ignition requires a short duration vary high power pulse at the end of the implosion that can be more easily formed by a separate group of beams.

The lasers are fired at a predetermined wavelength centered at 193 nm. The pulse is configured to have a predetermined temporal pulse shape, with the high power portion of the pulse having a predetermined duration of 2 to 4 nanoseconds and the pulse having a total duration of about 12 nanoseconds. The specific parameters can be are determined by the conditions in which a symmetric implosion is maintained long enough with sufficient compression to generate substantial fusion reactions within the target. These parameters can be determined ahead of time by radiation hydrocode simulations that have been tested against experiments. Starting with the parameters determined by the hydrocode simulations some tuning of the parameters, such as details of the pulse shape, would be performed to optimize the target implosion to maximize the thermonuclear burn of the fuel.

The pressure from the ArF laser drive accelerates the inner shell of the target capsule to hundreds of km/sec to form a spherical assembly of compressed fuel surrounding a “hot spot” that has sufficient temperature, density and size to ignite and initiate a thermonuclear burn. The burn then propagates out into the compressed fuel to achieve high fusion burn yield.

The present invention also provides an improved method for generating power from a fuel pellet using laser-driven inertial fusion. In accordance with the present invention, multiple ArF lasers having a central wavelength of 193 nm are directed at a spherical target comprising an outer ablator shell surrounding an inner shell comprising the fusion fuel. The ArF laser system of the present invention provides highly uniform spherical target illumination by multiple (1,000 to 10,000) overlapped beams providing laser energies of 0.3 to 2 MJ with peak intensities on target of 10¹⁵ to 10¹⁶ W/cm². The pressure from the ArF high-intensity laser drive accelerates the inner shell of the target capsule to hundreds of km/sec to form a spherical assembly of compressed fuel surrounding a “hot spot” that has sufficient temperature, density and size to ignite and initiate a thermonuclear burn. The burn then propagates out into the compressed fuel to achieve high fusion burn yield.

### BRIEF DESCRIPTION OF THE DRAWINGS

FIG. 1 is a block schematic illustrating aspects of an ArF laser amplifier used in a laser-driven inertial fusion energy system in accordance with the present disclosure.

FIGS. 2A and 2B illustrate aspects of a laser-driven inertial fusion energy system in accordance with the present invention.

FIG. 3 is a block schematic further illustrating aspects of an exemplary laser amplifier that can be used in a laser-driven inertial fusion energy system in accordance with the present invention.

FIGS. 4A and 4B are plots illustrating the utilization of etalons to provide broad bandwidth in 193 nm laser system.

FIG. 5 is a block schematic illustrating an exemplary embodiment of windowless amplifier that can be used in a laser-driven inertial fusion energy system in accordance with the present invention.

FIG. 6 is a block schematic illustrating exemplary components of a laser-driven inertial fusion energy system in accordance with the present invention.

FIG. 7 is a block schematic illustrating aspects of an exemplary laser configuration for a laser-driven inertial fusion energy system in accordance with the present invention, in which multiple laser beams are arranged to illuminate a small (2-4 mm) radius target that contains a fuel pellet to be imploded.

FIG. 8 is a schematic illustrating aspects of laser-plasma instabilities from a laser incident on a DT fuel pellet in an inertial fusion energy system such as that described in the present disclosure.

FIGS. 9A-9D are block schematics illustrating aspects of inertial fusion in a target pellet containing liquid DT fuel in a laser-driven inertial fusion energy system in accordance with the present disclosure.

FIG. 10 is a plot illustrating the results of one-dimensional simulations of the gain of shock ignition direct drive implosions as a function of laser energy for a frequency tripled Nd:glass glass laser driver (351 nm), a KrF driver (248 nm), and an ArF driver (193 nm).

FIGS. 11A and 11B are plots illustrating how the ArF laser driver has increased target pressure compared to other laser drivers and reduced instabilities for ArF laser driver compared to other laser drivers.

FIG. 12 is a block schematic illustrating aspects of energy gain produced in a laser-driven inertial fusion energy system in accordance with the present disclosure.

### DETAILED DESCRIPTION

The aspects and features of the present invention summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

The present invention focuses on a much-improved path to achieving DT fusion via ICF. However, it is feasible that a DT reaction could be used to ignite a larger DD reaction, thereby enabling transition from a capability of providing the world's energy needs for a few thousand years to a few billion. This would of course complement solar and wind sources of power, which are derived from the sun's fusion reactions.

Laser fusion has been considered as a power source dating back to the invention of the laser.

High-energy lasers have modest efficiency with projections of about 7% for an optimized krypton fluoride (KrF) laser system and claims of up to 15% for a frequency tripled diode pumped solid-state laser system. For the energy application, the product of the target gain times the laser system's wall plug efficiency needs to be at least 10 to enable that a large fraction of the generated power is available for the grid (rather than recirculated to power the laser). To build smaller lower cost laser fusion power plants another important parameter is the laser energy needed to achieve high-energy gain.

Argon fluoride (ArF) gas lasers and KrF gas lasers have been proposed as a driver for inertial confinement fusion (ICF) experiments since the 1980's. The inventors were the first to recognize, propose and develop the ArF laser as a very attractive driver for inertial fusion energy (IFE). See S. P. Obenschain et al., “Direct Drive with the Argon Fluoride laser as a path to high fusion gain with sub-megajoule laser energy,” Phil. Trans. A. Volume 378, Issue 218, (in press 2020) DOI https://doi.org/10.1098/rsta.2020.0031. (2020) (“Obenschain 2020”); see also G. M. Petrov et al., “Production of radical species by electron beam deposition in an ArF* lasing medium,” Journal of Applied Physics Volume 122, Issue 13, 7 Oct. 2017, Article number 133301; and M. C. Myers et al., “Development of An Electron-Beam Pumped, Argon Fluoride Laser for Inertial Confinement Fusion,” IEEE International Pulsed Power Conference Volume 2019-June, June 2019, Article number 9009786.

As an excimer gas laser, ArF shares other target physics advantages with KrF, including the capability to zoom the focus and ISI beam smoothing. These target physics advantages along with the projected relatively high intrinsic efficiency of the ArF laser motivated the exploration of the feasibility of building laser inertial fusion power plants by the NRL laser fusion program. This included examination of the feasibility of constructing the efficient high energy ArF systems required for inertial fusion energy systems. The conclusion was that use of an ArF driver could enable smaller lower cost laser fusion power plants than was previously thought to be feasible. See Obenschain 2020, supra.

Recently, researchers at the NRL have discovered that very substantial ICF physics advantages accrue with the change from 248 nm KrF light to 193 nm ArF light. See S. Obenschain, “The Argon Fluoride laser as high-performance driver for ICF/IFE,” Fusion Power Associates Meeting, December 2019, Washington D.C.; M. F. Wolford et al., “Development of a Broad Bandwidth 193 Nanometer Laser Driver for Inertial Confinement Fusion,” High Energy Density Physics, 36, 100801 (2020); and Phil Trans. A, Theme Issue “Prospects for high gain inertial fusion energy”—article #RSTA-2020-003 (in print 2020). These advantages include improved efficiency in compressing the target fuel so as to achieve ignition, improved suppression of laser-plasma instabilities, and greater opportunity to achieve robust high-energy gain conditions resulting from the winning combination of shorter wavelength and higher bandwidth from ArF as compared to KrF lasers. ArF is projected to be capable of providing much broader (3×) bandwidth light on target than KrF and is the shortest-wavelength known laser that can credibly scale to MJ class energies. Survey hydrocode simulations conducted at NRL indicate that robust ignition with direct drive is feasible with a sub-MJ ArF laser. High energy gains (>100) appear to be feasible with a laser much smaller than NIF (2 MJ) with ArF laser using direct drive. The deep ultraviolet (UV) beams would be also superior for indirect drive experiments but that is not regarded as a path to the high energy gains required for IFE. The higher ablation pressures available with an ArF driver would enable use of targets with lower radius to shell-thickness ratios. This would reduce the precision needed in the target fabrication and the laser illumination.

NRL simulations also indicate that an ArF laser could enable ICF target performance needed for IFE with much less energy required than currently used ICF lasers. Because of its deep UV light and other challenges such as the need to utilize electron beam pumping, ArF was considered by most to be too challenging a technology for even laboratory ICF experiments. However, the work at NRL indicates that ArF systems indeed can be built that meet the more stringent requirements of IFE. See M. F. Wolford et al., supra.

The present invention provides an energy-production system that uses such an ArF laser as the driver for an inertial fusion-based power plant. As described in more detail below, a laser-driven inertial energy fusion system in accordance with the present invention can include multiple ArF laser beams produced by multiple ArF beamlines, where the ArF laser beams can be used to directly illuminate a spherical target comprising an outer ablator wall surrounding an inner shell comprising the fusion fuel. The lasers are fired simultaneously at the capsule to form an ArF laser drive directed at the capsule if all the beams have the same temporal pulse shape. Alternatively, a portion of the laser beams can have a different pulse shapes to accommodate the short duration ignitor pulse needed for shock or fast ignition. The lasers are fired at a predetermined wavelength, typically about 193 nm, for a predetermined pulse duration of about 4 nanoseconds, although the specific parameters can be determined by the conditions in which a symmetric implosion can be maintained long enough to converge the target enough to generate substantial fusion reactions within the target.

The pressure from the ArF laser drive accelerates the inner shell of the target capsule to hundreds of km/sec to form a spherical assembly of compressed fuel surrounding a “hot spot” that has sufficient temperature, density and size to ignite and initiate a thermonuclear burn. The burn then propagates out into the compressed fuel to achieve high fusion burn yield.

Simulations discussed below indicate that the ArF laser can achieve much higher target performance than any other known laser capable of generating the power and energy needed for an inertial fusion implosion. ArF is projected be capable of a wall plug efficiency of 10%, well above that feasible (7%) with KrF and approaching that projected for frequency-tripled solid state lasers. This patent proposes the use of the ArF laser as a driver for a laser fusion power plant that would be more robust and scale to smaller size than systems using other laser drivers.

The inertial fusion-based power plant of the present invention uses an ArF laser as the driver because of its superior capability to efficiently implode targets to obtain high-fusion energy gain and because of its projected superior intrinsic efficiency compared to the next most efficient KrF excimer laser driver. The ArF laser's superior capabilities to obtain higher target performance are a result of its shorter-wavelength light (193 nm) versus the 351 nm wavelength light that can be obtained from frequency tripled solid solid-state lasers or the 248 nm light that can be obtained from a KrF laser. This shorter-wavelength light provides higher drive pressures at a given laser intensity and suppresses laser-plasma instabilities that cause losses and limit the maximum intensity and concomitant pressure that can be utilized to drive a fusion implosion. An ArF laser also has broader native laser bandwidth than the two other options, which further mitigates laser-plasma instability. The combination of short wavelength and broad bandwidth is projected to allow the use of a higher laser-induced pressure to drive low aspect ratio (radius/shell thickness) targets that are less susceptible to hydrodynamic instabilities and require less precision in both the target fabrication and the laser illumination of the target. The combination of reduced losses from LPI and higher hydrodynamic efficiency allows high target fusion energy gains for direct drive implosions than any other laser driver.

An ArF laser used in a laser-driven inertial energy system in accordance with the present invention can utilize electron-beam pumping similar to that used for large KrF amplifiers. It would also be able to use the beam smoothing technology demonstrated on Nike that enables uniform illumination of directly driven targets and provides the capability to “zoom” the focal profile to follow an imploding target. Uniform illumination is maintained by placing the Fourier plane of the high quality ArF laser source near the center of the amplifier. The Fourier plane is imaged relayed near the center of each successive amplifier where practical. KrF technology was chosen for the Nike facility because of numerous advantages for achieving laser fusion. ArF laser light in turn would be superior to KrF. Kinetics simulations indicate that ArF-based lasers would have as much as 1.6× higher intrinsic efficiency for the internal fusion energy (IFE) applications than would be possible using KrF lasers. These advantages would enable the development of modestly sized and low-cost power plant modules utilizing laser energies well below 1 MJ. This would drastically change the present view on IFE as being too expensive and the power plant size as too large.

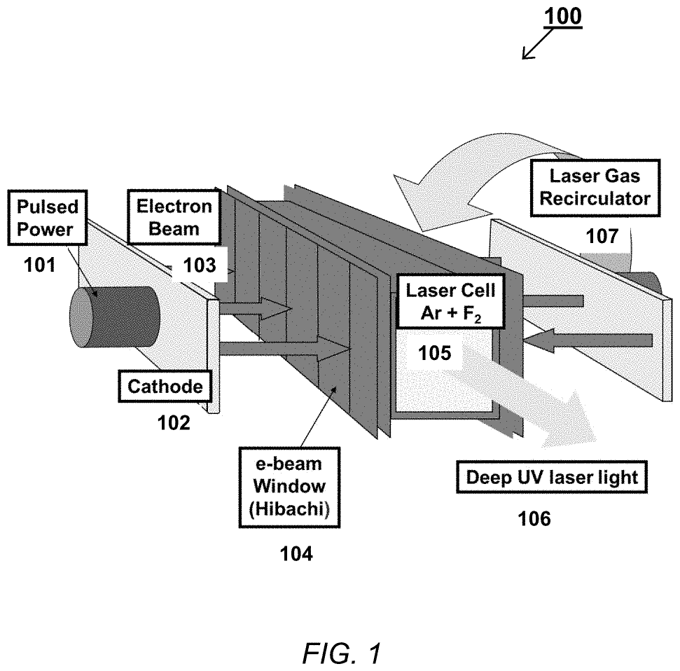

The block schematic in FIG. 1 illustrates an exemplary configuration of an electron-beam pumped pulsed-power ArF laser amplifier 100 that can be used in a laser-driven inertial fusion energy system in accordance with the present invention.

As illustrated in FIG. 1, such an electron-beam pumped pulse power ArF laser is composed of a pulsed power system 101 which supplies energy to the amplifier. The pulsed power system supplies a predetermined energy to a cathode 102 which emits electrons that form an electron beam 103 having a predetermined defined voltage, current and pulse shape. The electron beam, which initially is in a vacuum environment, passes through an electron beam window 104, typically a metal and/or alloy with a thickness on the scale of tens of microns. The electron beam window, thin foil of metal and/or alloy is supported by a structure often known in the art as a “hibachi.” The electrons in electron beam 103 are attenuated slightly in energy as they pass through electron beam window/hibachi 104 to a laser cell 105 composed of argon, fluorine and possibly another inert gas such as helium and/or neon. Laser cell 105 contains an admixture of laser components known in the art to provide stimulated emission in amplifier configuration. Note that in some embodiments, cathode 102 may be patterned to avoid the need for a hibachi structure as well to allow greater efficiency of the electron beam 103 into the laser cell 105.

Deep UV laser light 106 is emitted from the amplifier 100 to be used in the inertial fusion energy power plant. A laser gas recirculator 107 is utilized to allow high repetition rate and more economical potential of the inertial fusion power plant. The laser gas recirculator 107 moves the laser gas within the laser cell 105 up through a heat exchanger and muffler system to provide minimum density perturbations to allow high quality and high repetition rate of the laser system to be utilized to mitigate the impact of heating of the laser cell 105 from excess heat generated by the electron beam 103 dissipating its energy in the laser admixture.

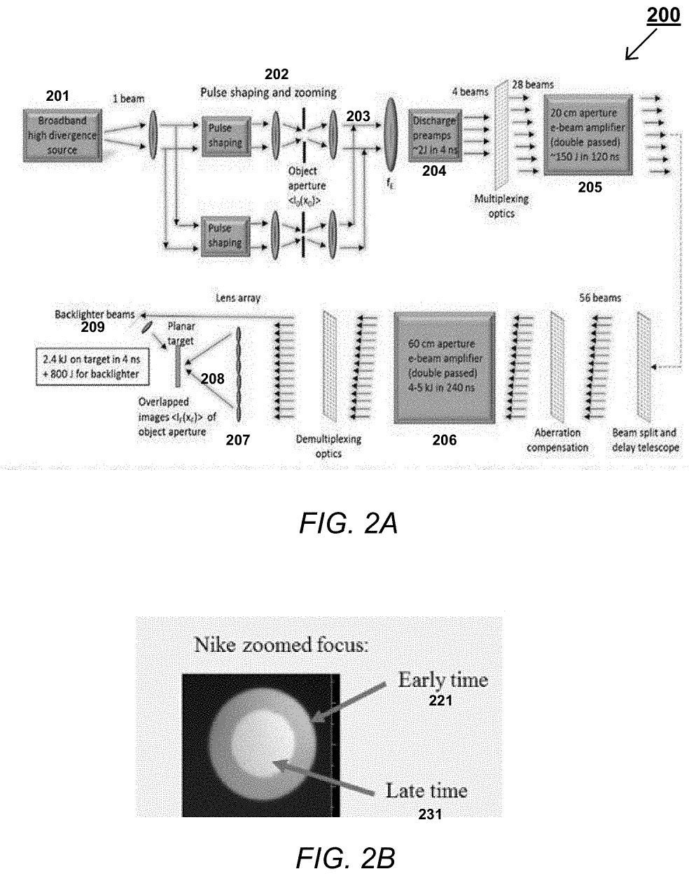

Both ArF and KrF laser systems need a multi-beam optical system to efficiently extract the energy from the electron-beam pumped amplifier depicted in FIG. 1. The block schematic in FIG. 2A illustrates an exemplary multi-beam optical system and amplifier staging for the Nike laser KrF system that can be used as a laser driver for a laser-driven internal fusion energy system in accordance with the present invention. See S. Obenschain et al., supra. A high-energy ArF laser system using angular multiplexing would use a similar optical configuration that could have different numbers of beams and different size and number of amplifiers.

The Nike system 200 illustrated in FIG. 2A includes a broadband spatially incoherent laser source 201 (a discharge pumped oscillator) typically having 1 to 3 THz bandwidth, 100 times diffraction-limited divergence, a pulse length of 20 ns and an initial pulse energy of 10's of mJ.

The initial pulses travel through a lens into pulse shaping and zooming component 202 which produces the desired pulse shape for example, using Pockels cell shutters known in the art, to produce pulses 203. These pulses 203 are directed into a series of discharge-pumped amplifiers 204 at the front end, where the initial pulses are amplified to a pulse energy of about 2 Joules (2 J) in about 4 ns.

These amplified pulses are then directed into a multiplexer which can increase the number of beams from, e.g., 4 beams into 28 beams. The multiplexed beams are then directed into a first electron-beam-pumped amplifier 205 such as that illustrated in FIG. 1, which increases the pulse energy to about 150 J in about 120 ns. The pulses are then split into two groups of 28 beams by a beam splitter. The split beams are then directed into a second electron-beam-pumped amplifier 206, which increases the pulse energy to about 4-5 kJ in about 240 ns. This pulse energy is nearly continuously extracted by a sequence of 56 short duration (4 to 5 ns) angularly-multiplexed beams that follow one another in time in a manner known in the art. See, e.g., U.S. Pat. No. 4,345,212 to Seppala and Haas. The 56 beams are sequential in time to extract the full amplifier duration, which is substantially longer than one individual laser beam pulse. The pulses are then directed through a lens array 207, where the laser focal profile on the target is determined by imaging a laser illuminated aperture located in the front end through the laser system onto the target.

This optical system allows easy implementation of focal zooming where the focal diameter is reduced during the pulse. This can be implemented as shown by utilizing two or more different diameter apertures in the front end. The numerous induced spatial incoherence (ISI) smoothed beams with up to 3 THz bandwidth provide extremely uniform time-averaged target illumination. See U.S. Pat. Nos. 4,790,627 and 4,521,075, supra. The image in FIG. 2B illustrates an exemplary focal profile of a laser pulse obtained with NRL's Nike laser facility. An ArF laser, with its 10 THz projected bandwidth, could provide still more uniform time-averaged target illumination. This approach cannot be implemented on Nd:glass or other solid state lasers for ICF because of nonlinear effects in the solid-state media in the amplifiers.

The basic laser configuration shown in FIG. 2A could also be used to build a high-energy ArF modular beamline consisting of several high-energy amplifiers and numerous beams. One might utilize a separate front end in each beamline. Alternatively, one could use the output of one or more front-ends to drive many beamlines. The number of beamlines, the number of beams in each beamline, and the size and energy of the ArF amplifiers are predetermined by the energy, target illumination, bandwidth and temporal, pulse shape needed to obtain high gain inertial fusion implosions. This would be in conjunction with requirements to minimize the cost and maximize the overall system performance.

In other embodiments, one or a few long duration KrF laser pulses can be used to extract energy from the laser amplifier, with each pulse being shortened by stimulated Raman or Brillouin backscatter in a gas cell after amplification.

Additional aspects of a an ArF amplifier and laser system that can be used in a laser-driven inertial fusion energy system in accordance with the present invention will now be described.

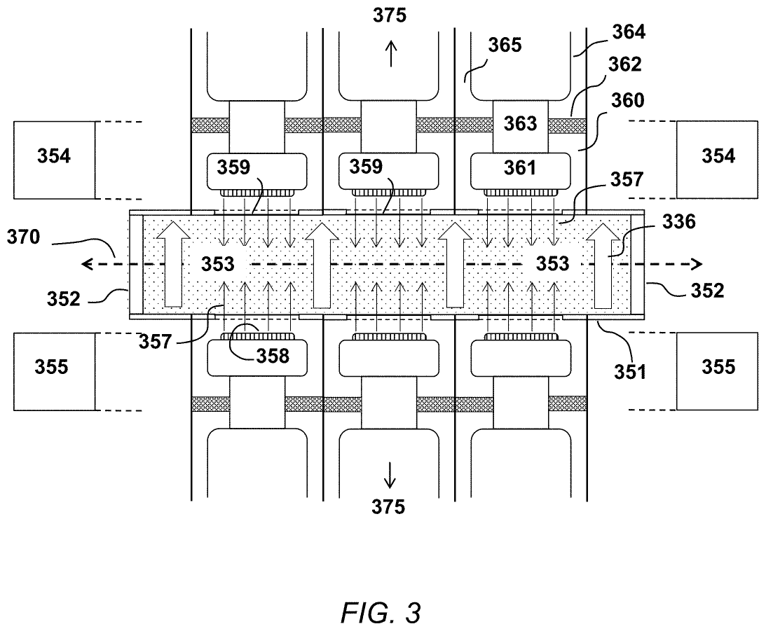

One embodiment of an electron beam pumped laser amplifier design uses transverse pumping, which is described in more detail in block schematic in FIG. 3.

The block schematic in FIG. 3 illustrates a horizontal cross-section through an exemplary embodiment of a laser amplifier that can be used in a laser-driven inertial fusion energy system in accordance with the present invention.

As illustrated in FIG. 3, chamber 351 contains an argon/fluorine laser gas mix (353) and is closed at each end by windows 352 that transmit 193 nm light. Magnetic field coils 354 and 355 provide a substantially uniform magnetic field illustrated by arrows 356, typically in the range of 0.1T to 0.4T, that is oriented transversely to the laser optical axis 370.

High voltage pulsed power, typically in the range of about 500 kV to about 1.0 MV, arrives via water (365)-filled transmission lines 364 that are fed by pulsed power generator(s) (not shown) situated in direction 375. The pulsed power generators in this embodiment are all-solid-state and therefore are capable of extended operation, for example for a period of one year at a pulsing frequency of 5 Hz, without requiring refurbishment of components. The pulsed power from the pulsed power generators is transmitted via bushings 363 to cathode surround structures 361. Cold cathode structures 358 face the gas volume and are typically rectangular in area with vertical extent matched to the depth (out of the page) of chamber 351. Volume 360 around the cathodes is evacuated to typically less than 10⁻² Pa via one or more pumps (not shown). Thin metal foil windows 359 are inserted into the wall of chamber 351 opposite cathodes 358, where the metal foils separate the laser gas 353 from vacuum region 360. These windows, which may be fabricated from stainless steel, titanium or other metal/alloy of thickness in the range 10 to 75 microns, transmit the electron beams from the cathode into the laser gas. Typically, support is needed for the differential pressure between gas and vacuum. The additional support of a highly transmissive ribbed structure referred to as a hibachi provides a definite location for the metal foil.

In operation, chamber 352 is evacuated and filled with a laser gas mixture, typically to pressures in the range 0.5 to 2.0 atmospheres (7.5 to 30 psia). The guide magnetic field 356 is established via currents in coils 354 and 355. Negative polarity high voltage pulses are applied to cathodes 358 relative to foil windows 359 at ground potential. Optionally there can be an anode mesh between a cathode and foil to establish a more uniform potential gradient within the electron gun. The applied pulses can typically have duration 150 ns to 300 ns at peak currents in the range of hundreds of kA depending on the total number N of cathodes feeding the amplifier chamber. The main purpose of the applied magnetic field 356 in this embodiment is to keep electrons flowing as directly as possible between the cathode and the foil.

Electrons entering the laser gas lose energy mainly to the dominant (>98%) argon component of the mixture via multiple excitation and ionization events. Excited argon states enter a chain of kinetic events that ultimately channels about 25% of the electron beam energy into the argon fluoride laser excited state ArF*. The magnetic field has a secondary role in that it also guides electron motion during this collisional slowing down, keeping most of the energy deposition within the extraction volume defined by the propagating laser beams.

Energy is extracted from the ArF* states by an array of intense 193 nm beamlets that propagate at slightly different angles (in two dimensions) relative to optical axis 170. These beamlets each consist of a short (few nsec) pulse of radiation and arrive sequentially so that energy is constantly extracted throughout the 150-300 ns electron beam excitation pulse. Subsequently they are collected by separate mirrors and their timing is corrected via varying optical delay paths to bring them back into synchronization, before the beams are sent to the laser fusion target chamber.

After an electron beam pulse the argon/fluorine gas mixture “recovers” to its initial state via electron-ion and heavy body recombination reactions. At a steady repetition frequency in this embodiment of 5 Hz to 15 Hz, the gas flow exchanges energy between pulses and excess heat does not build up. Depending upon the energy deposited, there can be a temperature impulse exceeding 100C during a pulse. Gas flow can be transverse to the optical axis and magnetic field directions, as used on the Electra laser demonstrated at NRL during tests of the KrF excimer laser.

Spectral modification of spatially incoherent broadband argon fluoride laser light prior to amplification aids in suppression of laser plasma instabilities in the laser target interactions.

The native bandwidth of argon fluoride emission is 19 THz full-width half-maximum (FWHM) and is centered at a wavelength of 193 nm. There is, however, spectral narrowing of the laser light at low energy levels as occurs, for example, when a 2.5 mJ pulse is amplified in successive stages to a 25 kJ output pulse, corresponds to an amplification factor of 10⁷. The calculated bandwidth after this “direct” amplification is 4 THz, whereas a broader bandwidth is desirable to help suppress laser-plasma instabilities that occur in the plasma corona of the fusion target. In an embodiment of this invention the spatially-incoherent broadband light in the ArF laser spectrum—or the spectrum at an early stage within the amplifier system—is further modified by passage through an etalon (known in the art) with free a spectral range comparable to the argon fluoride bandwidth.

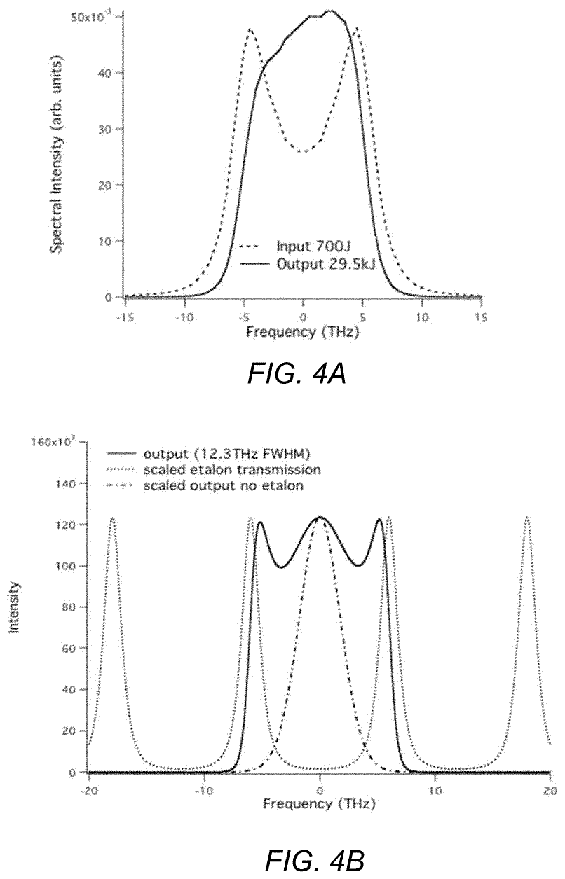

Calculations of the subsequent spectral evolution show that a 10 THz FWHM output can be generated using a single etalon, as illustrated by the plots shown in FIG. 4A. As can be seen from FIG. 4B, a 700 J input pulse with etalon-produced “wings” in its spectrum can generate a 30 kJ output pulse that has 2.5 times greater bandwidth than the 4 THz that would be obtained naturally during amplification. In another example, a pair of etalons was able to generate a “square” spectrum of 12 THz FWHM shown in FIG. 4B. Additional application of such procedures is expected to reach 15 THz or greater bandwidth at full energy.

An additional consideration in the design of an argon fluoride laser for fusion energy production is the pre-pulse leakage of amplified spontaneous emission (ASE) onto the target surface, which has to be sufficiently low to not cause plasma production in advance of the main drive pulse. ASE exists because in the multiplex geometry of this embodiment there are shorter paths to the target for ASE, which is emitted at all angles, than for many of the coherent beams, which are coded to propagate at specific angles. The emission of ASE by electron beam pumped excimer lasers is well understood.

A second source of pre-pulse on target it the beam-to-beam scattering from the optics within the angularly multiplexed amplifiers. This occurs due to scattering from roughness on the optical surfaces and from inhomogeneity inside the amplifier windows. The beam-to-beam-scattering can be mitigated but not entirely eliminated by employing optimized fabrication techniques to reduce scattering of the 193 nm light.

The maximum acceptable prepulse energy depends on the particular target design and moderate levels of prepulse (1-5 J/cm2) on target can be beneficial to the implosion if delivered uniformly and reproducibly to the target. Pre-pulse from ASE can be reduced linearly with the electron beam pulse duration τₚ. This also can lead to savings in optics cost and complexity. In this direction 150 ns pulsed power and 150 ns amplifier designs are conceptually possible. In the absence of these, a saturable absorber cell may be deployed in each of many beamlets between the penultimate and final amplifiers or in other locations within the optical train. This will reduce low level pre-pulse from both the beam-to-beam scattering and ASE from the preceding amplifiers. Gaseous materials that have broad absorption bands with large absorption cross sections at 193 nm include ammonia and iodine vapor, and these can be deployed as saturable absorbers in cells within the optical train where needed to suppress on-target pre-pulse energy.

The exit window of a double-pass ArF amplifier carries the highest 193 nm fluence within an angularly multiplexed system. Amplifiers in the 30 kJ class can have fluence from 6 to 12 J/cm² average at peak intensities up to 500 MW/cm², depending upon the tailored pulse shape and the chosen amplifier aperture.

At present, ArF grade calcium fluoride (CaF) windows have sufficiently high damage threshold that they would likely be applicable as windows, but are not presently commercially available in the 50 cm to 70 cm clear apertures needed for 30-kJ or larger amplifiers.

One solution is to utilize multiple smaller aperture windows in a windowpane configuration.

Another solution is a windowless amplifier, as described below. The advantages of this approach are that it would eliminate the need for large-damage-threshold windows for the amplifier as well as beam-to-beam scattering in the amplifier windows and would facilitate the use of vacuum beam paths after the amplifier. The disadvantages compared to utilizing windows are; (a) in a double-pass mirror design, the mirror would be exposed to the laser gas; (b) additional power is required to power the pumps; and (c) it precludes use of an inert gas such as argon or helium in the beam paths after the final amplifier.

To anticipate the possible degradation of the final amplifier output window under the regime of a power station we propose a system option in which the critical final amplifier output window is removed, while pressure in the pumped volume of the amplifier is set higher than within the adjacent optics tank via either pulsed or continuous gas flow. The gas flow/differential pumping challenge is manageable, at least on a pulsed basis, and the absorption loss due to un-pumped fluorine regions is only a few percent. An analogous but much more elaborate differential pressure scheme has been reported that enables extreme ultraviolet light, which has no usable window material at all, to be generated in a noble gas and propagated into the high vacuum of a proton accelerator storage ring. See M. Tschernajew et al., “Differential pumping unit for windowless coupling of laser beams to ultra-high vacuum,” Vacuum Vol. 178 (2020) 109443. As stated, the optics tank is free of oxygen, which absorbs at 193 nm and the tank is likely at vacuum. Preliminary considerations show that axial flow of the laser gas in a windowless system will have suitably good optical quality for the integrity of focusing on the fusion target.

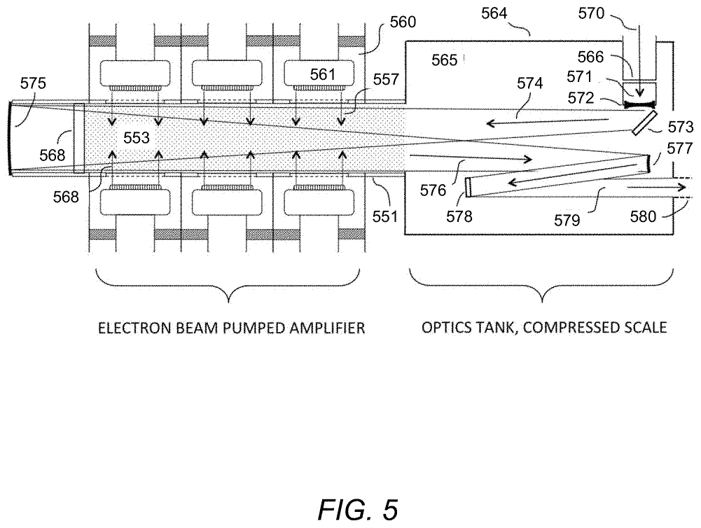

The block schematic in FIG. 5 illustrates an exemplary embodiment of a windowless amplifier that can be used in a laser-driven inertial fusion energy system in accordance with the present invention.

One embodiment of certain aspects of the invention is illustrated in FIG. 5, which shows a preferred optical arrangement for laser energy extraction. Evacuated optics tank 564 is drawn on an approximately tenfold compressed horizontal scale relative to that of the electron-beam-pumped amplifier so as to show the optical arrangement more clearly.

In operation, amplifier chamber 551 is filled with argon/fluorine laser gas mix 553. A high voltage pulse is applied to cathode surrounds 561 (six in this embodiment, but other numbers can be used) and the cathodes emit electron beams 557 that generate a density of ArF* excited states giving optical gain. The desired final optical pulse duration on target is a few nanoseconds but the electron beam pulses are longer than 100 ns, so that a plurality of optical beamlets is passed in succession through the gain medium 553, before being re-combined after appropriate optical delays to arrive in synchronism at the fusion target.

For the purpose of illustration, a single beamlet 570 is shown entering through window 566 into a saturable absorber cell 571, which may contain low-density ammonia gas or iodine vapor in order to reduce pre-pulse energy that could reach the target ahead of the main pulse. Each beamlet may have its own saturable absorber cell. Beamlet 570 leaves cell 571 via window 572 that is configured as a negative lens, and the beamlet is re-directed by plane mirror 573 toward the electron-beam-pumped amplifier. The beamlet expands (574) to fill the aperture of the amplifier for efficient energy extraction. The beam passes out of the gain medium via window 568 and is reflected at concave focusing mirror 575 to make a second transit through gain medium 553 and converges 576 onto convex re-collimation mirror 577. After recollimation, the now parallel beamlet is then subject to a pre-set optical delay via the longitudinal positioning of plane mirror 578, and proceeds as collimated beamlet 579 through an exit aperture into duct 580 that transports the radiation to final focusing optics and the target surface.

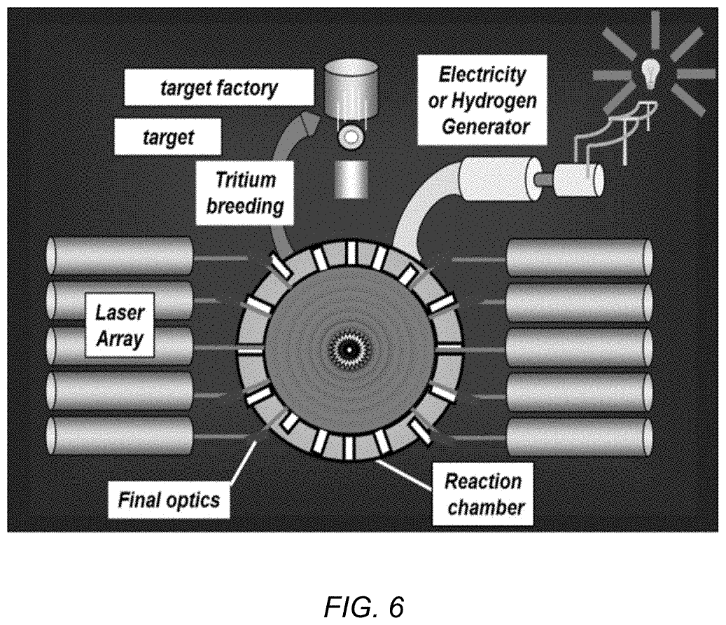

Such ArF lasers comprise one component of a laser-driven inertial fusion energy system in accordance with the present invention. As illustrated in FIG. 6, such a system can include one or more laser arrays, each comprising a predetermined number of ArF lasers configured to produce light in a predetermined deep UV waveband centered at 193 nm with bandwidth of up to 15 THz. The laser array provides the laser energy that passes through the final optics to enter the reaction chamber. The final optics are exposed to target emission including photons, neutrons, and ions. The walls of the reaction chamber include the final optics for the laser system and further include material which converts neutrons into tritium. Additionally, the walls collect other recyclable fuel components, including unburned deuterium. The process of conversion of neutrons interacting with a material and making tritium is termed tritium breeding. The tritium generated goes to the target factory, where targets for the reaction chamber are made, to be utilized in targets. The heat of the neutrons as well as any residual electrical energy generated directly form the fusion reactor is used to make electricity to be supplied to the electrical grid.

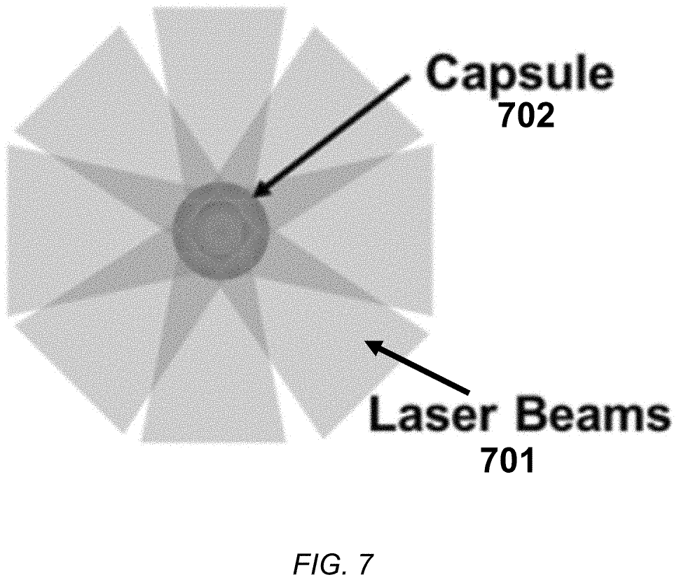

As illustrated by the block schematic in FIG. 6, in a laser-driven inertial fusion energy system in accordance with the present invention, multiple ArF laser beams produced by multiple ArF beamlines as illustrated in FIG. 2 can be used to directly illuminate a spherical target comprising an outer ablator wall surrounding an inner shell comprising the fusion fuel. In the exemplary embodiment illustrated in FIG. 7, the multiple ArF lasers can be arranged so that the beams 701 from those lasers are directed in a uniform circular array around a centrally-located target capsule 702. In many embodiments, the inner shell of this capsule comprises frozen deuterium-tritium (DT) or liquid DT contained in a plastic foam matrix.

As described above, laser beams 701 have been amplified by ArF electron-beam pumping to an energy of about 200 J in a beam line which are delivered in clusters of about 20 to 50 kJ. The temporal pulse shape and focal distribution of the beams on target is specified by the needs of a particular target design. When the spherical target 702 is illuminated by these multiple laser beams 701, the energy from the beams is focused onto the target and, because the beams are directed in a uniform circular array around the target, this energy produces a highly symmetric implosion of the target, compressing the fuel in the pellet and achieving central ignition. In an alternate configuration, called fast ignition, the pellet can first be compressed, with ancillary high-intensity beams igniting a small portion of the fuel situated near the center of the compressed pellet. In another configuration, the beams can illuminate the inner surface of a gold or other high-atomic number hohlraum that contains the fusion capsule where x-rays produced by the drive the capsule implosion.

In accordance with the present invention, the lasers are fired simultaneously at the capsule to form an ArF laser drive directed at the capsule if all the beams have the same temporal pulse shape. Alternatively, a portion of the laser beams can have a different pulse shape to accommodate the short duration ignitor pulse needed for shock or fast ignition. The lasers are fired at a predetermined wavelength for a predetermined pulse duration of about 4 nanoseconds. The specific parameters of the laser pulses are determined by the conditions in which a symmetric implosion can be maintained long enough and the target compressed sufficiently to generate substantial, enough for alpha heating, fusion reactions within the target.

The pressure from the ArF laser drive accelerates the inner shell of the target capsule to hundreds of km/s to form a spherical assembly of compressed fuel surrounding a “hot spot” that has sufficient temperature, density and size to ignite and initiate a thermonuclear burn wave. The burn wave then propagates into the compressed fuel layer to achieve high fusion yield. This approach is standard for all inertial fusion concepts using direct drive.

The products of the fusion reactions are collected in the walls of target chamber though which a fluid containing lithium flows. The first wall collects charged particles, x-ray emissions, and other heated debris from the target. The fluid behind the first wall collects the energy from stops the high energy neutron which contain most of the energy from the DT fusion reaction. The wall is located far enough from the target (about 6 to 8 meters) so that the energy it collects from a fusion implosion does not melt its surface. The energy from an implosion will provide about 80 to 240 MJ of energy. To provide high average power the implosions must occur at a repetition rate of about 10 pulses per second to produce 0.8 to 2.4 GW of fusion power. The fusion power collected by the first wall and the fluid behind it can then be used to produce steam or other suitable gas to drive electrical power generators as is standard practice in the power industry. The nuclear reactions on the fluid containing lithium produce additional tritium fuel and can provide a 10% increase in the thermal power.

The deuterium-tritium fuel mixture used in the target capsules in accordance with the present invention is initially at very low temperatures, typically less than 20 Kelvin, and is in either liquid or solid form. To obtain ignition and burn, a portion of the fuel must be compressed well above solid density and heated to a high temperature (about 50,000,000 to 100,000,000° C.). For the case of central ignition, only a portion of the fuel is heated to ignition temperatures, with this portion being surrounded by a much colder highly compressed (about 1000× solid density) fuel. The aim is to ignite the fuel in the hot spot, which causes the formation of a propagating burn wave in the surrounding compressed fuel. It takes less energy to compress the fuel than to heat it to high temperature, so this approach allows higher energy gain than if one were to heat all of the fuel. With this configuration, simulations indicate that energy gains, i.e., the ratio of the fusion energy output to the laser energy incident on the target, well above 100 are feasible, provided that the laser light is efficiently coupled to the imploding target and the target is imploded with sufficient symmetry and precision.

Laser fusion requires uniform illumination and precisely fabricated targets to achieve high performance implosions. Consequently, a laser-driven, inertial-fusion energy system in accordance with the present invention must take into account the effects of both hydrodynamic and laser-plasma interaction instabilities. The overall physics evaluation and target design determine the technical requirements (e.g., the exterior and interior target-surface qualities needed to avoid seeding significant hydrodynamic instabilities and the short- and long-scale uniformity of the laser illumination).

The goal of the target design is to minimize the requirements for both the target and the laser while achieving high performance implosions.

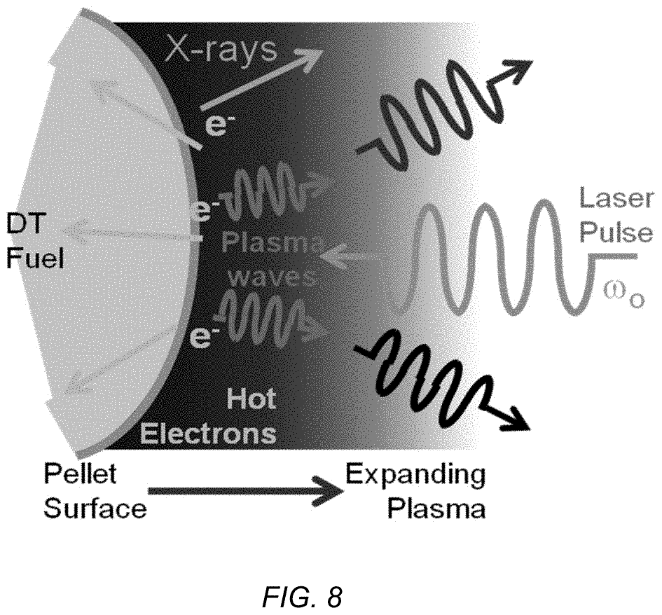

Laser-plasma instabilities can affect the production of energy in an inertial fusion energy system such as that described in the present disclosure. The schematic in FIG. 8 illustrates this, wherein energy is removed prior to reaching the target through multiple different processes. These laser-plasma instabilities limit the laser intensity and ablation pressures that can be achieved. Laser-plasma instabilities can (a) cause scattering loss of the laser light which reduces the energy deposited in the target; and (b) produce energetic “hot electrons” that can penetrate the target and preheat the fuel so as to spoil high compression. Such laser-plasma instabilities can thereby impair the target implosion performance, which would result in reduced fusion-energy gain.

Using an ArF laser in the laser-driven fusion energy system in accordance with the present invention ameliorates these problems. The superior laser-target coupling possible ArF's deep UV light (193 nm) enables the high target gains needed for energy applications at a much lower laser energy than previously thought feasible, while the combination of deep UV light and broad native bandwidth (>5 THz) suppresses the laser-plasma instabilities that limit the laser intensity and ablation pressures possible using conventional, 351-nm, frequency-tripled Nd:glass lasers which have heretofore been used as the laser drivers for inertial confinement fusion.

The best strategy to defeat the limits set by such laser-plasma instabilities is to employ the shortest practical laser wavelength capable of providing broad (multi-THz) bandwidths. A white paper submitted to the National Academies describes the potential of bandwidth and deeper UV light to mitigate laser-plasma instabilities and thereby enable high-performance direct-drive implosions. See S. P. Obenschain et al., “Science and technologies that would advance high-performance direct-drive laser fusion,” white paper submitted to the Nat. Acad. 2020 Decadal Study of Plasma Phys.: #41 in submitted papers.

A recently conceived high-performance direct drive method called shock ignition is predicted to provide higher gains than earlier conventional designs. See R. Betti et al., “Shock Ignition of Thermonuclear Fuel with High Areal Density,” Phys. Rev. Lett. 98 (2007) 155001; and J. W. Bates et al., “Simulations of high-gain shock-ignited inertial-confinement-fusion implosions using less than 1 MJ of direct KrF-laser energy,” High Energy Density Physics 6 (2010) 128-134. ArF is predicted to have the potential to provide substantially higher gains than KrF for shock-ignition target designs.

In shock ignition, the pellet shell is accelerated to lower implosion velocity than in conventional “hot spot” target designs, and ignition is achieved by a short-duration high-intensity laser spike at the end of the pulse that launches a high pressure “ignitor” shock.

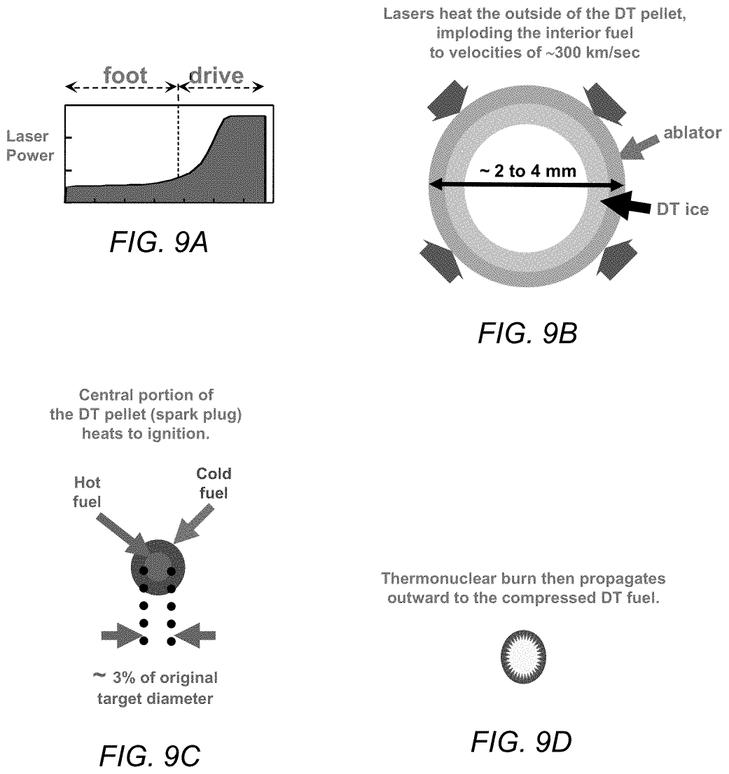

The impartation of energy from an ArF laser into a target pellet containing liquid DT fuel described above can also be used as part of a shock ignition system. The block schematics in FIGS. 9A-9D illustrate aspects of such a design. A temporal profile of an exemplary laser pulse that can be used to create such a shock-ignited implosion is shown in FIG. 9A. As shown in FIG. 9, the pulse comprises a “foot” portion, which is a long low-intensity section of the pulse which preconditions the target fuel. This is followed by a longer high-intensity pulse that then drives the implosion of the target.

As shown in FIG. 9B, when the laser pulse interacts with the outer surface of the target, energy from the pulse launches a spherical shock wave that propagates inward to the target's center (FIG. 9C). During this process, a fraction of the outer layer of the target is preserved in the form of cold thermonuclear fuel, which is then “burned” once the fusion reactions near the center of the target occur with sufficient frequency to launch a sustained, outward-propagating, thermonuclear burn wave (FIG. 9D).

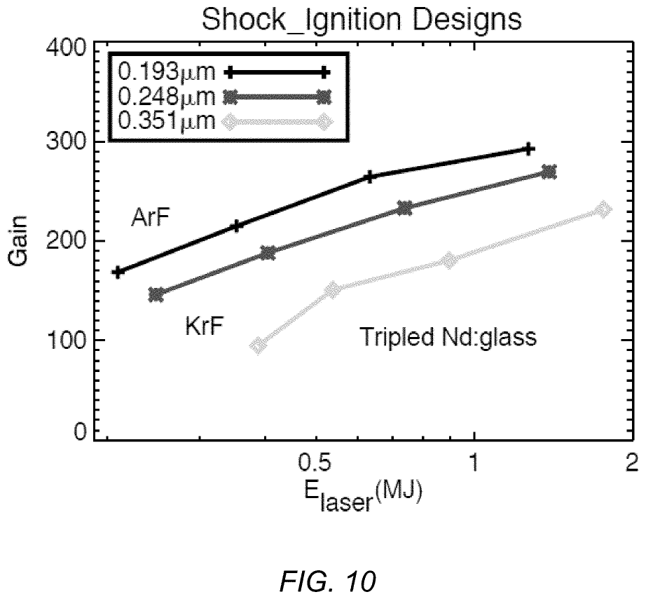

The plot in FIG. 10 illustrate the results of one-dimensional simulations of energy gains with shock ignition targets as a function of laser energy for a frequency-tripled Nd:glass glass laser driver (351 nm), a KrF driver (248 nm), and an ArF driver (193 nm). The gains shown are derived from a limited number of simulations and do not represent the absolute maximum gains that could be achieved.

As can be seen from FIG. 10, the gains are highest with the shorter wavelength excimer drivers. Shock ignition has the potential to provide higher energy gains than conventional designs meaning that one would need less driver energy to reach a given yield. For the case of an ArF 1 MJ driver, the predicted yield is 170 MJ for a conventional design and 280 MJ for shock ignition designs. The simulated performance is most likely to be approached with KrF/ArF excimer drivers due to the superior target illumination capability and the mitigation of laser-plasma instabilities.

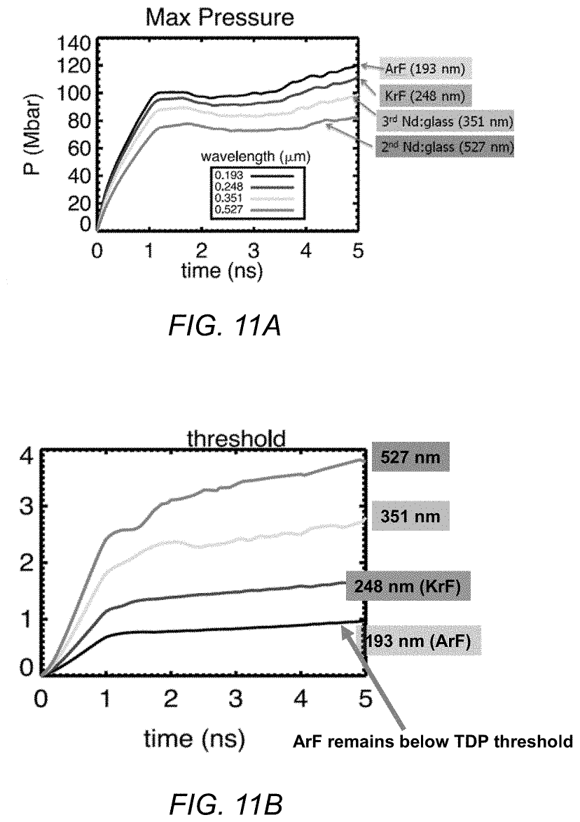

The plots in FIGS. 11A and 11B further illustrate the effect of wavelength on power generated in a laser-fusion energy system. Light from an ArF laser deposits more power onto the surface of a direct-drive target than other contemporary ICF lasers due to its shorter wavelength (i.e., higher photon energy) and broader bandwidth. The effect of the higher energy and broader bandwidth increases the likelihood of successful implosions (i.e., high fusion-energy gains) by driving the target harder as well as increasing the stability through a reduction in the time required for an implosion to occur.

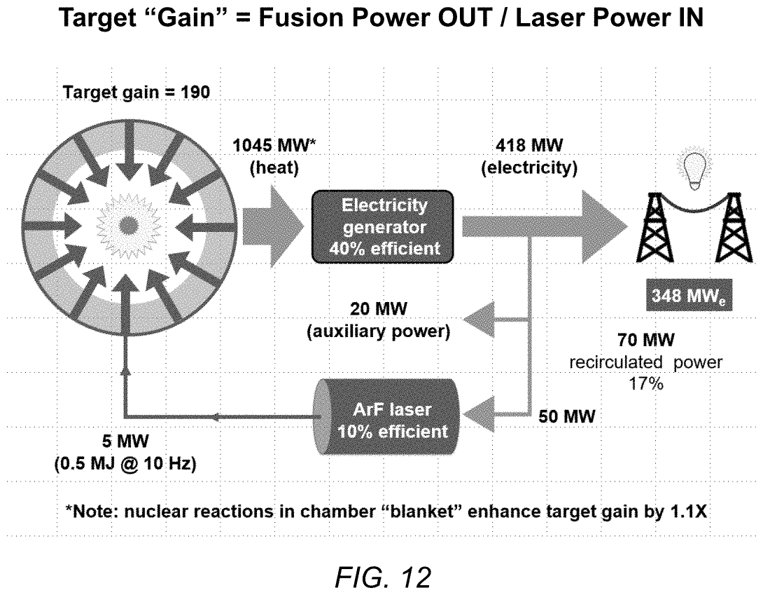

The expected good “wall plug” efficiency (10%+) and high target gains (>>100) at sub-megajoule energies enable smaller, cheaper, inertial-fusion power plants with an ArF driver. The block schematic in FIG. 12 illustrates an exemplary power-flow diagram for a power plant using a 0.5 MJ ArF laser with 10% efficiency and a shock-ignited target design with a gain of 190×. The large product of laser efficiency and energy gain allows most of the produced electricity to be distributed to the grid. In order to be economically viable as a power generation source the recirculating power, the power going back to run the device, must be kept low. Therefore, high target gain and high laser efficiency is desirable and minimally required at some economic level.

### Advantages and New Features

The combination of excellent target performance and good wall-plug efficiency would enable construction of laser fusion power plans of much smaller size and cost than previously thought to be feasible.

Some embodiments of the present invention enable a shorter wavelength to be employed in the laser driver, which suppresses deleterious laser-plasma instabilities and for the case of direct laser drive, increases the hydrodynamic efficiency of the implosion.

Some embodiments enable the use of multi-THz bandwidth laser light, which further suppresses laser-plasma instabilities and, for the case of laser direct drive, enables more uniform time-averaged illumination of the target than contemporary laser drivers. ArF is the only avenue to obtain laser wavelength as short as 193 nm in concert with multi-THz bandwidth at the high laser energy needed for inertial fusion. The present invention enables relatively high electrical efficiency for delivering laser light to the target, which is projected to be about 10%. Direct-drive target simulations conducted at NRL project that fusion energy gains of about 100× (compared to the laser energy) are needed to utilize an ArF laser as the driver for fusion power plants and that this can be achieved with laser energies of less than 1 MJ.

Laser inertial fusion energy has the advantage of component modularity and “separability” in the development of power plants. For example, the laser driver will consist of numerous beamlines. One can design, build and test a single beamline prior to constructing a full size facility. In addition, while the target physics does vary with laser energy, it does not vary with the repetition rate. The implosion performance can be verified first on a low-repetition-rate facility.

Argon fluoride (ArF) is currently the shortest-wavelength laser that can credibly scale to the energy and power required for high-gain inertial fusion. ArF's deep ultraviolet light and capability to provide much broader laser bandwidth than contemporary ICF drivers would drastically improve the laser-target coupling efficiency and enable substantially higher pressures for driving an ICF implosion. Use of an ArF driver in an IFE system in accordance with the present invention would significantly reduce the size and cost of such a facility.

Radiation-hydrodynamics simulations by the inventors have indicated that fusion energy gains greater than 100 are feasible with a sub-megajoule ArF driver. Laser kinetics simulations by the inventors have indicated that electron-beam-pumped ArF lasers can have intrinsic efficiencies greater than 16%, versus about 12% for the next most efficient krypton fluoride (KrF) excimer laser. It can also be expected that a “wall plug” efficiency of at least 10% can be achieved with an ArF laser using solid-state pulsed power and efficient electron-beam transport to the laser gas (similar to that which was demonstrated with NRL's Electra facility). These advantages could enable the development of modest size and lower-cost fusion-power-plant modules. This would drastically change the present view on inertial fusion energy as being too expensive and the power plant size as being too large.

Higher pressure drive allows for the use of thicker-walled, smaller-radii targets that require less precision in the laser illumination and the target fabrication compared to other laser drivers.

The combination of high projected target-energy gain at lower laser energy and 10% (or more) wall plug efficiency would enable construction of smaller, lower-cost, inertial-fusion power plants.

The advantages of using an ArF driver are projected to apply to all directly-driven laser-fusion designs including: conventional central ignition and shock-ignition designs. It would also be advantageous for the implosion phase of fast ignition and may be advantageous for the high-intensity pulse stage as well, which is used to ignite a hot spot on the exterior of the compressed target.

Other advantages of using an ArF driver for laser directly driven implosions include:

Superior coupling to the target, higher drive pressure at a given laser irradiance.

Broad bandwidth enables more uniform illumination of the target using ISI beam smoothing.

The laser focal-spot diameter can be zoomed down to follow an imploding pellet thereby increasing the absorption efficiency; this is a trait shared with the KrF laser.

The combination of shorter wavelength and broad bandwidth suppresses laser-plasma instabilities and allows higher pressure drive for the implosion.

Higher pressure drive allows use of thicker-walled, smaller-radius pellets that require less precision in the laser illumination and the target fabrication compared to other laser drivers.

The combination of high projected target energy gain at lower laser energy and 10% or more wall plug efficiency would enable construction of much smaller, lower-cost inertial fusion power plants.

The advantages of using an ArF driver are projected to apply to all directly-driven laser-fusion designs including: conventional central ignition and shock-ignition designs. It would also be advantageous for the implosion phase of fast ignition and may be advantageous for the high intensity pulse that ignites a hot spot on the exterior of the compressed target.

An ArF driver enables the use of higher drive pressures and more uniform illumination of an ICF target than other laser drivers. The higher drive pressure enables the use of a thicker-walled target with a lower ratio of target radius to shell thickness. A lower target-to-shell ratio is desirable because it is more robust to hydrodynamic instabilities; this reduces the required precision in both the target-surface roughness and the laser illumination uniformity for a successful implosion.

The ArF driver also would allow higher target performance than any other known laser driver that can scale to the required energies.

The ArF driver is projected to be capable of wall plug efficiencies of at least 10%.

The combination of excellent target performance and good efficiency would enable construction of laser fusion power plans of much smaller size and cost than previously thought to be feasible.

### Alternatives

Alternatives include the use of frequency-tripled diode-pumped solid-state lasers and the KrF laser as drivers for a power plant. These drivers would have less efficient coupling to the target, require higher laser energy, and would have increased risk of failure due to hydrodynamic and laser-plasma instabilities compared to the ArF laser. These drivers would require construction of larger power plants than is required with an ArF laser driver.

In some embodiments, ArF discharge-pumped amplifiers can be used rather than electron beam pumped amplifiers. Discharge-pumped lasers have not demonstrated scalability to the large energies needed for IFE. However, ArF discharge-pumped amplifiers would be utilized in the low energy sections of an ArF system.

In some embodiments, it may be possible to utilize a means to impose broad bandwidths on frequency-tripled solid state lasers, KrF or ArF lasers to achieve broader bandwidths and thereby suppress LPI. An Optical parametric amplifier (OPA) technology is being developed at the University of Rochester which is applicable to frequency-tripled solid state lasers, and a system using stimulated rotational Raman scattering (SRRS) is being developed at NRL that is applicable to all three drivers. Because SRRS gain is inversely proportional to laser wavelength, an ArF laser has an inherent advantage in implementing this technique in an IFE laser system. SRRS could be utilized to further increase the bandwidth of an ArF laser system and further suppress LPI.

An ArF inertial fusion system can generate high thermal power at high temperatures limited only by the limits of the materials used to construct it. That heat could be used for applications other than power production such as synthetic fuel production and disposal of certain chemical and biological hazards. Deuterium-tritium fusion reactions produce copious high-energy neutrons that can be utilized for nuclear transmutations processes such as the creation of fuels for fission reactors, the disposal of radioactive waste, and/or the creation of useful isotopes.

There also have been some competitive approaches to the ArF laser driver.

For example, it has been proposed that multi-THz bandwidths can be applied to current ICF lasers by means of stimulated rotational Raman scattering (SRRS) in a diatomic gas (see D. Eimerl et al., “Large Bandwidth Frequency-Converted Nd:Glass Laser at 527 nm with Δv/v=2%,” Phys. Rev Lett., vol. 70, no. 18, pp. 2738-2741, 1993; and J. Weaver et al., “Spectral and far-field broadening due to stimulated rotational Raman scattering driven by the Nike krypton fluoride laser,” Applied Optics, vol. 56, no. 31, pp. 8618-8631, 2017) or by means of an optical parametric amplifier at the end of the laser system (see C. Dorrer et al., “High-energy parametric amplification of spectrally incoherent broadband pulses,” Optics Express, vol. 28, no. 1, pp. 451-471, 2020). Both have been demonstrated in the laboratory, but their practically for large systems is unproven. These approaches would not provide the short wavelength provided by ArF unless an ArF laser was employed. Of the two approaches, only SRRS is applicable to ArF with current optical technologies, and it might be used to enhance the ArF bandwidth beyond its native capacity.

Another means to obtain effective broad laser bandwidth is described in U.S. Pat. No. 10,660,192 to Campbell et al., “Flexible driver laser for inertial fusion energy.” The system proposed in the '192 patent utilizes many narrowband laser beams with an array of different wavelengths to achieve, effectively, broadband laser light on the target. The '192 patent, though, is most applicable to solid-state laser technologies for which the shortest wavelength that can be efficiently generated is 351 nm. The bandwidth that can be achieved with the approach described in the '192 patent could be more or less than is feasible with an ArF driver, depending on the solid-state laser media employed. The advantages of the ArF driver described in this patent application include the use of shorter laser wavelength (193 nm vs 351 nm) and the fact that all the ArF beams would be broad bandwidth (vs. narrow-bandwidth individual beams). Consequently, the ArF system would provide more uniform time-averaged illumination at a given bandwidth.

In addition, focal zooming can be achieved easily in each beam with ArF. See D. M. Kehne et al., “Implementation of focal zooming on the Nike KrF laser,” Rev. Sci. Instrum., vol. 84, no. 013509, pp. 013509-1-013509-4, 2013. In comparison, there is no straightforward way to implement focal zooming with a solid-state laser. Overall, an ArF system would employ fewer amplifiers, require less complicated pulse, spectral and focal-distribution shaping systems than its solid-state counterpart and, based on the KrF/ArF experience at NRL, is deemed to be an overall simpler system to construct.

Aspects of a laser-driven inertial fusion energy system and an ArF laser amplifier and laser system that can be used therein have been described. Although particular embodiments, aspects, and features have been described and illustrated, one skilled in the art would readily appreciate that the invention described herein is not limited to only those embodiments, aspects, and features but also contemplates any and all modifications and alternative embodiments that are within the spirit and scope of the underlying invention described and claimed herein. The present application contemplates any and all modifications within the spirit and scope of the underlying invention described and claimed herein, and all such modifications and alternative embodiments are deemed to be within the scope and spirit of the present disclosure.

What is claimed is:

1. An argon fluoride (ArF) laser system for inertial nuclear fusion energy production comprising:
(a) at least one discharge-pumped pulsed laser source emitting spatially incoherent broadband argon fluoride (ArF) laser light centered at 193 nm, the ArF laser light being in the form of an initial laser pulse having an initial diameter;
(b) at least one spatial, temporal, and spectral optical pulse shaping element that receives the ArF laser light from the laser source;
(c) a first set of beam splitting and steering elements that receive the ArF laser light from the laser sources and convert the ArF laser light into a plurality of temporally and angularly coded sequences of ArF laser pulses;
(d) a plurality of discharge-pumped amplifiers that receive the temporally and angularly coded sequences of ArF laser pulses from the beam splitting and steering elements and increase the power of the received ArF laser pulses to form a first sequence of amplified ArF laser pulses;
(e) a plurality of electron-beam pumped amplifiers that receive the first sequence of amplified ArF laser pulses and further increase the power of the received ArF laser pulses to form a second sequence of amplified ArF laser pulses; and
(f) a sequence of de-multiplexing optical elements that bring the second sequence of amplified ArF laser pulses into temporal synchronism and spatial superposition at the surface of a fusion target containing deuterium and tritium.

2. The ArF laser system according to claim 1, wherein the de-multiplexing optical elements include a windowless de-multiplexing optical tank; and
wherein the second sequence of amplified ArF laser pulses communicate directly with the windowless de-multiplexing optical tank.

3. The ArF laser system according to claim 2, wherein a laser gas flows axially through the electron beam pumped amplifier in either pulsed or continuous mode.

4. The ArF laser system according to claim 1, wherein the second sequence of amplified ArF laser pulses uniformly illuminate the fusion target.

5. The ArF laser system according to claim 1, wherein the optical pulse shaping element rapidly reduces the initial diameter of the ArF laser light so that its diameter matches a predetermined target compression within two or more steps.

6. The ArF laser system according to claim 1, further comprising means for modifying a spectrum of the ArF laser light.

7. The ArF laser system according to claim 5, wherein the means for modifying a spectrum of the ArF laser light comprises an etalon.

8. The ArF laser system according to claim 1, further comprising means for modifying the first sequence of amplified ArF laser pulses, said means being situated between a first and a second amplifier to mitigate the effects of spectral narrowing in subsequent amplifiers.

9. The ArF laser system according to claim 1, the system further comprising at least one etalon, wherein the ArF laser light passes through the etalon to increase a laser bandwidth of the second sequence of amplified ArF laser pulses illuminating the target.

10. The ArF laser system according to claim 8, wherein the etalon has a free spectral range corresponding to a bandwidth of the ArF laser light.

11. The ArF laser system according to claim 1, wherein the second sequence of amplified ArF laser pulses have an on-target optical bandwidth in the range 3 THz to 15 THz full width at half maximum centered at 193 nm.

12. The ArF laser system according to claim 1, wherein the second sequence of amplified ArF laser pulses to achieve a predetermined uniformity of illumination of the target when time averaged over a predetermined time period.

13. The ArF laser system according to claim 1, wherein the second sequence of amplified ArF laser pulses illuminates the target with on-target laser energy of about 0.2 MJ to a 2.0 MJ.

14. The ArF laser system according to claim 1, wherein the second sequence of amplified ArF laser pulses provide a predetermined peak intensity on the target of 10¹⁵ to 10¹⁶ W/cm².

15. The ArF laser system according to claim 1, further comprising at least one saturable absorber cell positioned in the optical path between the ArF laser source and the target, wherein the saturable absorber cell is configured to suppress on-target pre-pulse energy of the laser pulses.

16. The ArF laser system according to claim 1, further comprising at least one saturable absorber cell containing low pressure ammonia, low pressure iodine vapor gas positioned in the optical path between the ArF laser source and the target, wherein the saturable absorber cell is configured to suppress on-target pre-pulse energy of the laser pulses.

17. The ArF laser system according to claim 1, wherein the ArF laser light is propagated between system amplifiers and between the final amplifiers and the target focusing optics in vacuo or an inert gas atmosphere.

18. A laser fusion power generating facility, including:
(a) an argon fluoride (ArF) laser, the ArF laser comprising:
(i) at least one discharge-pumped pulsed laser source emitting spatially incoherent broadband argon fluoride (ArF) laser light centered at 193 nm, the ArF laser light being in the form of an initial laser pulse having an initial diameter;
(ii) at least one spatial, temporal, and spectral optical pulse shaping element that receives the ArF laser light from the laser source;
(iii) a first set of beam splitting and steering elements that receive the ArF laser light from the laser sources and convert the ArF laser light into a plurality of temporally and angularly coded sequences of ArF laser pulses;
(iv) a plurality of discharge-pumped amplifiers that receive the temporally and angularly coded sequences of ArF laser pulses from the beam splitting and steering elements and increase the power of the received ArF laser pulses to form a first sequence of amplified ArF laser pulses;
(v) a plurality of electron-beam pumped amplifiers that receive the first sequence of amplified ArF laser pulses and further increase the power of the received ArF laser pulses to form a second sequence of amplified ArF laser pulses; and
(vi) a sequence of de-multiplexing optical elements that bring the second sequence of amplified ArF laser pulses into temporal synchronism and spatial superposition at the surface of a fusion target containing deuterium and tritium;
(b) a production facility configured to produce deuterium/tritium fusion targets;
(c) a reaction chamber that is essentially evacuated wherein the laser-target interaction occurs;
(d) a lithium-containing blanket around the reaction chamber to breed tritium fuel for target fabrication;
(e) a coolant system to transport heat away from the reaction chamber; and
(f) a turbine system to generate electricity.

19. The laser fusion power generating facility according to claim 16, wherein the target is illuminated by on-target laser energy of about 0.3 MJ to 2.0 MJ.

20. A method for generating power, comprising:
firing a plurality of ArF laser pulses towards a centrally situated spherical target capsule having an outer ablator shell surrounding an inner shell comprising a fusion fuel, each laser pulse having a central wavelength of 193 nm and having a predetermined pulse profile and pulse duration, the laser pulses being further configured to have laser energies of 0.3 to 2 MJ with peak intensities on the target of 10¹⁵ to 10¹⁶ W/cm²;
wherein the lasers are arranged radially around the target capsule and being configured to provide uniform spherical illumination of the target; and
wherein energy from the laser pulses is transferred to the target and generating sufficient pressure on the target to accelerate the inner shell of the target capsule to hundreds of km/sec so as to form a spherical assembly of compressed fuel surrounding a hot spot within the fusion fuel, the hot spot having sufficient temperature, density and size to ignite and initiate a thermonuclear burn which then propagates out into the compressed fuel to achieve high fusion burn yield.
